(19) United States
(12) Patent Application Publication
(10) Pub. No.: US 2010/0295457 A1
(43) Pub. Date: Nov. 25, 2010

(54) LIGHT CONTROL SYSTEM AND CONTROL METHOD THEREOF

(75) Inventors: Chih Hung LU, Hsin-Chu (TW); Cho Yi Lin, Hsin-Chu (TW)

Correspondence Address: LOWE HAUPTMAN HAM & BERNER, LLP, 1700 DIAGONAL ROAD, SUITE 300, ALEXANDRIA, VA, 22314, US

(73) Assignee: PIXART IMAGING INC., Hsin-Chu (TW)

(21) Appl. No.: 12/723,522

(22) Filed: Mar. 12, 2010

(30) Foreign Application Priority Data
May 20, 2009 (TW) 098116678

(51) Int. Cl. H05B 37/02

(52) U.S. Cl. 315/159

(57) ABSTRACT

A light control system includes at least one illumination module and a remote controller. Each illumination module includes an identification signal generator, at least one light source, a receiving unit and a control circuit. When the receiving unit receives a first wireless control signal, the control circuit controls the identification signal generator to emit an identification signal; when the receiving unit receives a second wireless control signal, the control circuit controls the ON/OFF of the light source. The remote controller sends the first and second wireless control signals to the illumination module, acquires the identification signal emitted from the identification signal generator to generate a plurality of images, and identifies the illumination module according to the images. The present invention further provides a control method of a light control system.

### CROSS REFERENCE TO RELATED APPLICATION

This application claims the priority benefit of Taiwan Patent Application Serial Number 098116678, filed on May 20, 2009, the full disclosure of which is incorporated herein by reference.

### BACKGROUND

1. Field of the Invention

This invention generally relates to a light control system and a control method thereof and, more particularly, to a light control system incorporating an image sensor and a control method thereof.

2. Description of the Related Art

Please refer to FIG. 1, it shows a conventional indoor light control system 9. The light control system 9 includes at least one lamp 91 and at least one mechanical switch 92, wherein each mechanical switch 92 is electrically connected to at least one lamp 91 through a control line 93 so as to control the ON/OFF of the lamp 91.

However, as the mechanical switch 92 is generally installed on the surface of wall, not only the eye is offended but poor contact occurs due to frequent operation such that the mechanical switch 92 needs to be replaced from time to time. In addition, the wall surface around the switch is frequently touched when a user switches the mechanical switch 92 such that the wall is easily smudged and needs to be cleaned frequently. Furthermore, since the control line 93 has to be installed under the wall surface, not only higher cost is required during installation but the maintenance and replacement of the control line 93 will take more money and time. When the number of the lamp 91 is numerous and each lamp 91 needs to be controlled independently, a plurality of mechanical switches 92 and complicated control lines 93 are required so as to implement the independent control of each lamp 91. However, the operating complexity and installation cost will be significantly increased.

Accordingly, it is necessary to further provide a light control system and a control method thereof so as to solve the problems existed in the above mentioned conventional light control system.

### SUMMARY

The present invention provides a light control system, in which no physical control line needs to be constructed during installation so as to simplify the installation procedure and to reduce the system cost.

The present invention provides a light control system, wherein each illumination module may be manufactured as an individual one so as to simplify the maintenance and replacement thereof.

The present invention provides a light control system, wherein each illumination module may be manufactured as an individual one and it is not necessary to construct physical control lines during installation thereby having higher expandability.

The present invention provides a control method of a light control system, wherein a plurality of illumination modules may be controlled by a single remote controller so as to simplify the operating procedure of the light control system.

The present invention provides a control method of a light control system, wherein a remote controller may be used to simultaneously control the ON/OFF of a part of a plurality of illumination modules according to actual requirement thereby having higher operating flexibility.

The present invention provides a light control system including at least one illumination module and a remote controller. The illumination module includes an identification signal generator, at least one light source, a receiving unit and a control circuit. The identification signal generator is configured to emit invisible light with a modulation frequency. The receiving unit is configured to receive a first wireless control signal and a second wireless control signal. When the receiving unit receives the first wireless control signal, the control circuit controls the identification signal generator to emit the invisible light; and when the receiving unit receives the second wireless control signal, the control circuit controls the ON/OFF of the light source. The remote controller includes a transmitter, an image sensing module and a processing unit. The transmitter is configured to send the first wireless control signal and the second wireless control signal. The image sensing module acquires the invisible light emitted from the identification signal generator to generate a plurality of images. The processing unit identifies the illumination module according to the images and controlling the transmitter to send the first wireless control signal and the second wireless control signal.

The present invention further provides a control method of a light control system including at least one illumination module and a remote controller, and the illumination module includes at least one light source. The control method includes the steps of: sending a first wireless control signal with the remote controller; receiving the first wireless control signal and emitting an identification signal with the illumination module; acquiring the identification signal with the remote controller to generate a plurality of images; identifying the illumination module according to the images and accordingly sending a second wireless control signal with the remote controller; and receiving the second wireless control signal with the illumination module and controlling the ON/OFF of the light source of the illumination module according to the second wireless control signal.

The present invention further provides a control method of a light control system including a plurality of illumination modules and a remote controller, and each illumination module includes at least one light source. The control method includes the steps of: sending a first wireless control signal to the plurality of illumination modules with the remote controller; emitting different identification signals with the illumination modules respectively; acquiring the identification signals with the remote controller to generate a plurality of images; identifying different illumination modules with the remote controller according to the images; and sending a second wireless control signal with the remote controller to the illumination modules to control the ON/OFF of the light source of selected illumination modules.

The control method of a light control system of the present invention, before the step of identifying different illumination modules with the remote controller according to the images, further includes a step of: setting a window of interest (WOI) in the images. In this manner, the remote controller may identify the illumination modules in the window of interest according to the acquired images and emits a second wireless control signal to the illumination modules to control the ON/OFF of the light source of the illumination modules whose image is included in the window of interest.

In the light control system and control method thereof, the light source of the illumination module may be any proper light source; for example, but not limited to, a fluorescent light, an incandescent lamp, a halogen light, a light emitting diode, an organic light emitting diode and their composition.

In the light control system and control method thereof, the invisible light emitted by the identification signal generator of the illumination module may be an infrared light or an ultraviolet light. The control circuit modulates the invisible light with a modulation frequency such that the modulated invisible light may be served as the identification signal of different illumination modules.

In the light control system and control method thereof, the modulation frequency of the invisible light emitted by the identification signal generator of each illumination module is preferably a multiple of that of other illumination modules. The sampling frequency of the image sensing module is preferably synchronize to and a common multiple of all of the modulation frequencies of the invisible light, such that the image sensing module may regularly acquire the invisible light emitted by all identification signal generators.

In the light control system and control method thereof, the ON/OFF of one or a plurality of illumination modules may be controlled by pressing at least one button on the remote controller. When it is desired to simultaneously control the ON/OFF of a plurality of illumination modules, a selected set of illumination modules may be turned on or turned off simultaneously. For example, when the button is pressed the first time, a set of illumination modules may be turned on or turned off together; and when the button is pressed the second time (pressed again), another set of illumination modules may be turned on or turned off together. In this manner, the practicability of the light control system of the present invention can be increased significantly.

### BRIEF DESCRIPTION OF THE DRAWINGS

Other objects, advantages, and novel features of the present invention will become more apparent from the following detailed description when taken in conjunction with the accompanying drawings.

FIG. 1 shows a schematic diagram of a conventional indoor light control system.

FIG. 2 shows a schematic diagram of the light control system in accordance with an embodiment of the present invention.

FIG. 3a shows a schematic diagram of the illumination module in accordance with an embodiment of the present invention.

FIG. 3b shows a schematic diagram of the illumination module in accordance with another embodiment of the present invention.

FIG. 4 shows a schematic diagram of identification signals emitted by different illumination modules included in the light control system in accordance with the embodiment of the present invention.

FIG. 5 shows a flow chart of the control method of a light control system in accordance with an embodiment of the present invention.

FIG. 6 shows a flow chart of the control method of a light control system in accordance with another embodiment of the present invention.

FIG. 7 shows a schematic diagram of controlling the ON/OFF of an illumination module with a remote controller included in the light control system in accordance with the embodiment of the present invention.

FIG. 8 shows a schematic diagram of controlling the ON/OFF of a plurality of illumination modules with a remote controller included in the light control system in accordance with the embodiment of the present invention.

FIG. 9 shows another schematic diagram of controlling the ON/OFF of a plurality of illumination modules with a remote controller included in the light control system in accordance with the embodiment of the present invention.

FIG. 10 shows another schematic diagram of controlling the ON/OFF of a plurality of illumination modules with a remote controller included in the light control system in accordance with the embodiment of the present invention.

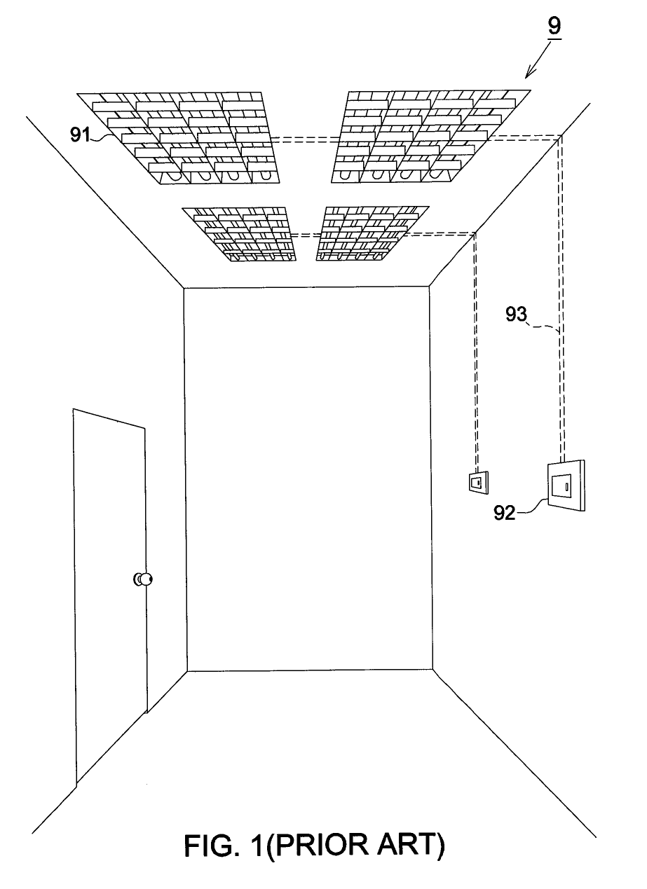

### DETAILED DESCRIPTION OF THE EMBODIMENT

It should be noticed that, wherever possible, the same reference numbers will be used throughout the drawings to refer to the same or like parts.

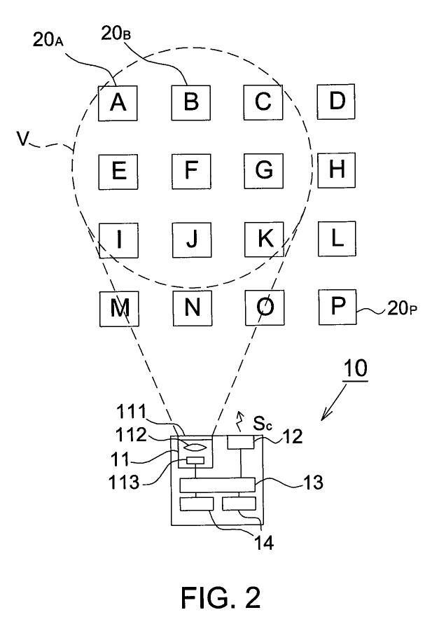

Please refer to FIG. 2, it shows a schematic diagram of the light control system according to an embodiment of the present invention. The light control system includes a remote controller 10 and a plurality of illumination modules 20, e.g. illumination modules 20_{A}˜20_{P}. The remote controller 10 is configured to control the ON/OFF of the light source included in one or a part of the illumination modules 20.

The remote controller 10 includes an image sensing module 11, a transmitter 12, a processing unit 13 and at least one button 14, wherein the processing unit 13 is coupled to the image sensing module 11, the transmitter 12 and the button 14. The image sensing module 11 is configured to acquire images of an identification signal emitted from the illumination modules 20. The transmitter 12 is configured to send a wireless control signal Sc to the illumination modules 20 so as to accordingly control the illumination modules 20 to emit the identification signal or to control the ON/OFF of the light source included in the illumination modules 20, wherein the transmitter 12 may communicate with the illumination modules 20 through, for example Bluetooth or the like, to implement the transmission of the wireless control signal Sc. The processing unit 13 is configured to control the image sensing module 11 to start to or stop acquiring images, to identify different illumination modules 20 according to the images of the identification signals acquired by the image sensing module 11, and to control the transmitter 12 to send the wireless control signal Sc. The button 14 is configured for being pressed by a user (not shown) to enable the operation of the light control system.

For example in an embodiment, when the button 14 is pressed continuously, the processing unit 13 controls the transmitter 12 to emit a first wireless control signal Sc₁ to the illumination modules 20 to have them emit the identification signal; meanwhile the processing unit 13 controls the image sensing module 11 to acquire images with a sampling frequency. When the button 14 is released from the pressed state, the processing unit 13 controls the transmitter 12 to send a second wireless control signal Sc₂ to the illumination modules 20 so as to accordingly control the ON/OFF of the light source included in one or a part of the illumination modules 20.

In another embodiment, when the button 14 is pressed the first time, the processing unit 13 controls the transmitter 12 to send a first wireless control signal Sc₁ to the illumination modules 20 to have them emit an identification signal; meanwhile the processing unit 13 controls the image sensing module 11 to acquire images with a sampling frequency. When the button 14 is pressed the second time, the processing unit 13 controls the transmitter 12 to send a second wireless control signal Sc₂ to the illumination modules 20 so as to accordingly control the ON/OFF of the light source included in one or a part of the illumination modules 20. It is appreciated that, the operation corresponding to the method of pressing the button 14 may be set according to actual applications and is not limited to those described herein.

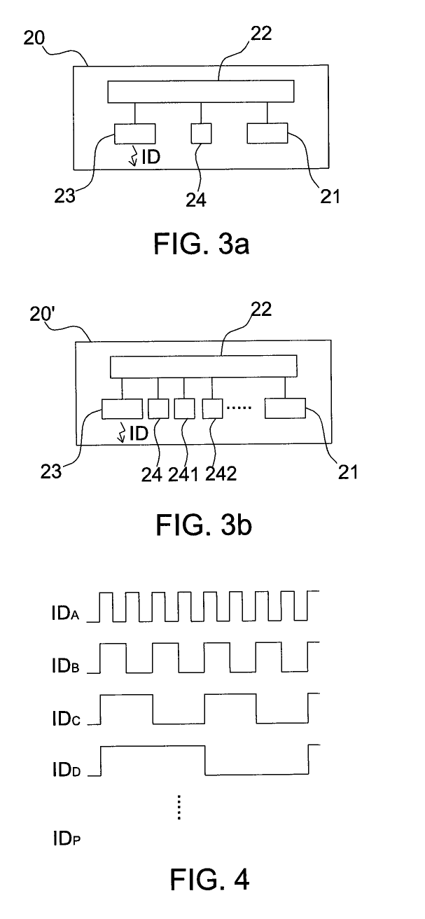

Please refer to FIGS. 3a and 3b, they respectively show a schematic diagram of the illumination module 20 according to an embodiment of the present invention. An illumination module 20 includes a receiving unit 21, a control circuit 22, an identification signal generator 23 and a light source 24, wherein the control circuit 22 is coupled to the receiving unit 21, the identification signal generator 23 and the light source 24. FIG. 3b shows the illumination module 20′ according to another embodiment of the present invention, which includes a plurality of light sources 24, 241, 242, and so on.

The receiving unit 21 is configured to receive the wireless control signal Sc sent from the transmitter 12 of the remote controller 10, wherein the signal transmission and communication between the transmitter 12 and the receiving unit 21 may be implemented by wireless communication techniques, e.g. Bluetooth or the like. When the control circuit 22 confirms that the receiving unit 21 receives the first wireless control signal Sc₁ from the remote controller 10, the control circuit 22 controls the identification signal generator 23 to emit an identification signal ID. When the control circuit 22 confirms that the receiving unit 21 receives the second wireless control signal Sc₂ from the remote controller 10, the control circuit 22 controls the ON/OFF of the light source 24 (and/or 241, 242, and so on). Embodiments of the identification signal generates 23 include a light emitting diode (LED), an infrared light emitting diode (IR LED) and a laser diode (LD). The identification signal generator 23 of each illumination module 20 is controlled by corresponding control circuit 22 to emit invisible light, e.g. an infrared light or an ultraviolet light, with a modulation frequency to be served as the identification signal ID. Embodiments of the light source 24 include, but not limited to, a fluorescent light, an incandescent lamp, a halogen light, a light emitting diode, an organic light emitting diode and their composition.

Please refer to FIGS. 2 and 4, FIG. 4 shows the modulated invisible lights, which are served as the identification signal ID of different illumination modules 20, emitted by the identification signal generator 23 of some illumination modules 20 according to the embodiment of the present invention, wherein ID_{A} refers to the identification signal of the illumination module 20_{A}; ID_{B} refers to the identification signal of the illumination module 20_{B}, and so on. In this embodiment, the frequency of ID_{A} is two times of that of ID_{B}, the frequency of ID_{B} is two times of that of ID_{C}, and so on. In another embodiment, the modulation frequency of the identification signal ID emitted by the identification signal generator 23 of each illumination module 20 is preferably a multiple, e.g. 1.5 times, 2 times, 2.5 times, 3 times, and so on, of that of other illumination modules 20.

The image sensing module 11 further includes a filter 111, a lens (or lens set) 112 and an image sensor 113. The filter 111 is for blocking the light with a spectrum outside the spectrum of the invisible light emitted by the identification signal generator 23 so as to eliminate the interference from ambient light. The lens 112 is for adjusting the sensing efficiency of the image sensor 113. Embodiments of the image sensor 113 include, but not limited to, a CCD image sensor and a CMOS image sensor. The image sensor 113 has a field of view V and is for acquiring the invisible light emitted by the identification signal generator 23 of the illumination modules 20 inside the field of view V to generate a plurality of images, and sends the acquired images to the processing unit 13. The processing unit 13 identifies different illumination modules 20 according to different modulation frequencies (e.g. those shown in FIG. 4). It is appreciated that, in order to allow the image sensor 113 to regularly acquire images of the identification signal ID emitted by all identification signal generators 23, the sampling frequency of the image sensor 113 is preferably synchronize to and a common multiple of the modulation frequencies of all identification signals ID. It is appreciated that, a shape of the field of view V is not limited to a circle, and FIG. 2 is only exemplary rather than a limitation of the present invention.

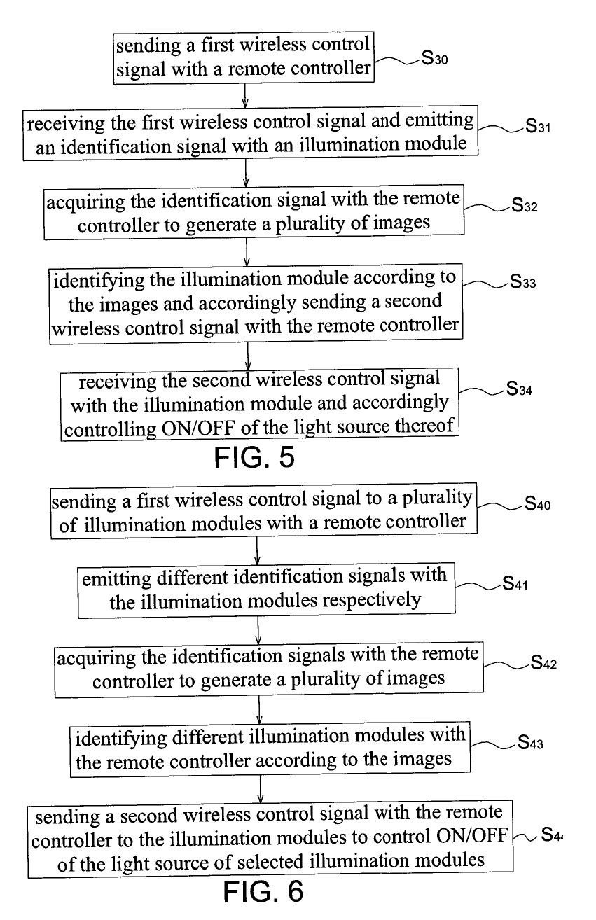

Please refer to FIG. 5, it shows a flow chart of the control method of a light control system in accordance with an embodiment of the present invention. The control method includes the steps of: sending a first wireless control signal with the remote controller (Step S₃₀); receiving the first wireless control signal and emitting an identification signal with an illumination module (Step S₃₁); acquiring the identification signal with the remote controller to generate a plurality of images (Step S₃₂); identifying the illumination module according to the images and accordingly sending a second wireless control signal with the remote controller (Step S₃₃); and receiving the second wireless control signal with the illumination module and accordingly controlling the ON/OFF of the light source thereof (Step S₃₄).

Next, details of the control method shown in FIG. 5 will be illustrated hereinafter. Please refer to FIGS. 2, 3 and 5, when a user (not shown) would like to control the ON/OFF of at least one of the illumination modules 20_{A}˜20_{P}, the user points the remote controller 10 to at least one illumination module 20 and presses the button 14 on the remote controller 10 to have the processing unit 13 control the transmitter 12 to send a first wireless control signal Sc₁ (Step S₃₀). All illumination modules 20_{A}˜20_{P} will receive the first wireless control signal Sc₁. When the control circuit 22 of every illumination module 20 confirms the first wireless control signal Sc₁, the control circuit 22 controls corresponding identification signal generator 23 to emit an identification signal ID, e.g. the illumination module 20_{A} emits an identification signal ID_{A}, the illumination module 20_{B} emits an identification signal ID_{B}, and so on. (Step S₃₁). The image sensor 113 of the remote controller 10 acquires the identification signal ID of the illumination module 20 inside the field of view V thereof, e.g. the illumination module 20_{A}, with a sampling frequency so as to generate a plurality of images, wherein the sampling frequency is preferably synchronize to and a multiple of the frequency of the identification signal ID such that the image sensor 113 may regularly acquire images of the identification signal ID emitted from the identification signal generator 23 (Step S₃₂).

In this manner, the processing unit 13 may identify the identification signal ID from different illumination modules 20 according to the frequency (i.e. regularity) of the image of the identification signal ID appeared in the captured images. Next, the processing unit 13 controls the transmitter 12 to send a corresponding second wireless control signal Sc₂. (Step S₃₃), wherein the frequency of the second wireless control signals Sc₂ for different illumination modules 20 may be different from each other. For example, in an embodiment, the frequency of the second wireless control signal Sc₂ may be identical to that of the identification signal ID_{A} of the illumination module 20_{A} when it is desired to enable the illumination module 20_{A}, but the present invention is not limited to this. After the control circuit 22 of the illumination module 20 inside the field of view V, e.g. the illumination module 20_{A}, confirms its corresponding receiving unit 21 receives the second wireless control signal Sc₂, the control unit 22 controls the ON/OFF of the corresponding light source 24 (Step S₃₄).

Please refer to FIG. 6, it shows a flow chart of the control method of a light control system in accordance with another embodiment of the present invention. The control method includes the steps of: sending a first wireless control signal to a plurality of illumination modules with the remote controller (Step S₄₀); emitting different identification signals with the illumination modules respectively (Step S₄₁); acquiring the identification signals with the remote controller to generate a plurality of images (Step S₄₂); identifying different illumination modules with the remote controller according to the images (Step S₄₃); sending a second wireless control signal with the remote controller to the illumination modules to control the ON/OFF of the light source of selected illumination modules according to an identification result (Step S₄₄).

Next, details of the control method shown in FIG. 6 will be illustrated hereinafter. Please refer to FIGS, 2, 3 and 6, when a user would like to control the ON/OFF of a plurality of illumination modules 20_{A}˜20_{P} simultaneously, e.g. the ON/OFF of the illumination modules 20_{A}˜20_{C}, 20_{E}˜20_{G} and 20_{I}˜20_{K}, the user points the remote controller 10 to the illumination modules 20_{A}˜20_{C}, 20_{E}^{˜}20_{G} and 20_{I}˜20_{K} and presses the button 14 on the remote controller 10 to have the processing unit 13 control the transmitter 12 to send a first wireless control signal Sc₁. All of the illumination modules 20 will receive the first wireless control signal Sc₁ (Step S₄₀). When the control circuit 22 of every illumination module 20 confirms the first wireless control signal Sc₁, the control circuit 22 controls corresponding identification signal generator 23 to emit identification signals ID_{A}˜ID_{P}, wherein the identification signals ID are modulated invisible light with a predetermined modulation frequency (Step S₄₁). The image sensor 113 of the remote controller 10 acquires, with a sampling frequency, the identification signals, e.g. ID_{A}˜ID_{C}, ID_{E}˜ID_{G} and ID_{I}˜ID_{K}, emitted from the identification signal generator 23 of the illumination modules, e.g. 20_{A}˜20_{C}, 20_{E}˜20_{G} and 20_{I}˜20_{K} as shown in FIG. 2, inside the field of view V thereof to generate a plurality of images (Step S₄₂); wherein the sampling frequency is preferably synchronize to and a common multiple of those modulation frequencies such that the image sensor 113 may regularly acquire images of the identification signal ID emitted from the identification signal generator 213 of the illumination modules 20. Accordingly, the processing unit 13 may identify the identification signal ID from different illumination modules, e.g. 20_{A}˜20_{C}, 20_{E}˜20_{G} and 20_{I}˜20_{K}, according to the frequency (regularity) of the identification signal ID appeared in the captured images so as to identify different illumination modules 20 (Step S₄₃). In an embodiment, the processing unit 13 may identify a selected part of the identification signals whose image are included in the captured images according to a predetermined rule (details will be illustrated below) rather than identify all identification signals included in the captured images. Finally, the processing unit 13 controls the transmitter 12 to send a corresponding second wireless control signal Sc₂ so control the ON/OFF of the light source included in the selected illumination modules; wherein the second wireless control signal Sc₂ for different illumination modules 20 may have different frequencies.

In the present invention, the above mentioned predetermined rule is that the processing unit 13 processes the part inside a predetermined window of interest (WOI) of the captured images and ignores other parts. The step of setting the WOI may be performed before Step S₄₃. That is, when the WOI in the captured images is selected, the remote controller 10 identifies the illumination modules 20 inside the selected WOI according to the captured images and sends a second wireless control signal Sc₂ to the illumination modules 20 to control the ON/OFF of the light source 24 of the illumination modules inside the selected WOI, e.g. 20_{A}˜20_{C}, 20_{E}˜20_{G} and 20_{I}˜20_{K}.

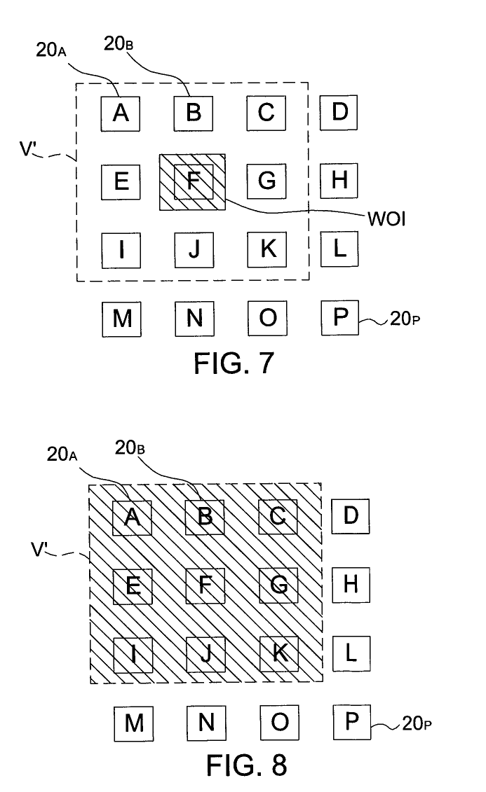

Please refer to FIG. 7, for example in an embodiment, the processing unit 13 is preset only to process the center part of a field of view V′ (shown as a square herein) and to ignore other image information inside the field of view V′. Accordingly, when the remote controller 10 sends the first wireless control signal Sc₁, the identification signal generator 23 of the illumination modules 20_{A}˜20_{P} emits light according to their own modulation frequencies. The image sensor 113 then acquires images of the identification signal generator 23 inside the field of view V′ and transmits the captured images to the processing unit 13. Since the processing unit 13 is preset to only process the image information inside the WOI, the processing unit 13 only identifies the identification signal ID_{F} from the illumination module 20_{F}. Next, the processing unit 13 sends a second wireless control signal Sc₂ to the illumination module 20_{F} to turn on or turn off the light source 24 (241, 242, and so on) included therein.

Please refer to FIG. 8, it shows that the WOI processed by the processing unit 13 is preset as the whole area of the field of view V′. Therefore, when the remote controller 10 sends the first wireless control signal Sc₁, the identification signal generator 23 of the illumination modules 20_{A}˜20_{P} emits light according to their own modulation frequencies. The image sensor 113 then acquires images of the identification signal generator 23 inside the field of view V′ and transmits the captured images to the processing unit 13. After the processing unit 13 identifies the identification signals ID_{A}˜ID_{C}, ID_{E}˜ID_{G} and ID_{I}˜ID_{K} in the captured images, it controls the transmitter 12 to sequentially send the second wireless control signal Sc₂ with frequencies identical to the modulation frequencies of the identification signals ID_{A}˜ID_{C}, ID_{E}˜ID_{G} and ID_{I}˜ID_{K}, e.g. sending the second wireless control signal Sc₂ in a sequence of Sc_{2A}, Sc_{2B}, Sc_{2C}, Sc_{2E}, Sc_{2F}, Sc_{2G}, Sc_{2I}, Sc_{2J}, Sc_{2K}, wherein Sc_{2A} refers to the second wireless control signal Sc₂ with the frequency identical to the modulation frequency of the identification signal ID_{A}; Sc_{2B} refers to the second wireless control signal Sc₂ with the frequency identical to the modulation frequency of the identification signal ID_{B}; SC_{2C} refers to the second wireless control signal Sc₂ with the frequency identical to the modulation frequency of the identification signal ID_{C}, and so on. After the control circuit 22 of the illumination modules 20_{A}˜20_{C}, 20_{E}˜20_{C} and 20_{I}˜20_{K} confirms the receiving of corresponding second wireless control signal Sc₂, it controls the ON/OFF of the corresponding light source 24.

It is appreciated that the frequency of the second wireless control signal Sc₂ sent from the transmitter 12, which is controlled by the processing unit 13, is not limited to be identical to the modulation frequency of the identification signal ID. In another embodiment, as long as the control circuit 22 is preset to be able to identify corresponding frequency, the frequency of the second wireless control signal Sc₂ sent by the transmitter 12 may not be equal to the modulation frequency of the identification signal ID. Furthermore, the sequence of the frequencies that the processing unit 13 controls the transmitter 12 to send the second wireless control signal Sc₂ mentioned above is only exemplary and is not a limitation of the present invention.

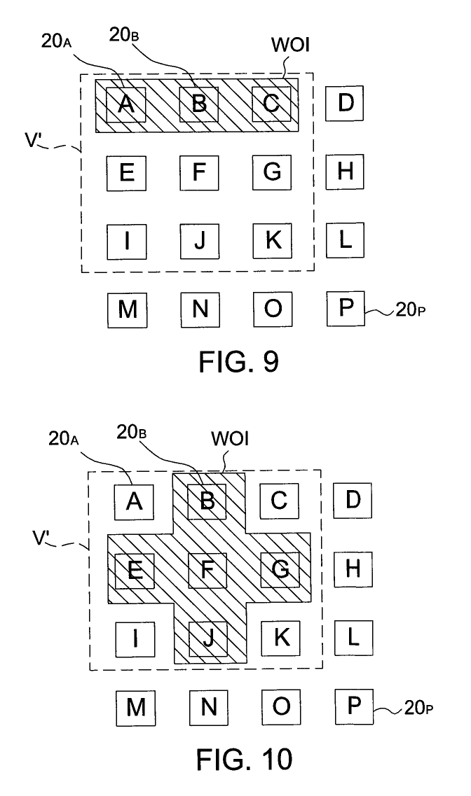

It is appreciated that the preset WOI processed by the processing unit 13 is not limited to those shown in FIGS. 7 and 8. For example in FIG. 9, the WOI may be preset as the upper part of the field of view V′; wherein the method that the remote controller 10 controls the ON/OFF of the illumination modules 20_{A}˜20_{C} is similar to that shown in FIG. 8 and thus details will not be repeated herein. In another embodiment, as shown in FIG. 10, the WOI may be preset as the middle part of the field of view V′ along the vertical and horizontal directions to form a cruciate region; wherein the method that the remote controller 10 controls the ON/OFF of the illumination modules 20_{B}, 20_{E}˜20_{C} and 20_{J} is similar to that shown in FIG. 8 and thus details will not be repeated again.

As mentioned above, mechanical switches used in the conventional light control system will deteriorate with time and there are physical control lines needed to be constructed during installation to increase the cost of time and money. The present invention provides a light control system and a control method thereof (FIGS. 2 and 5-6), in which no physical control line needs to be constructed during installation such that the light control system of the present invention has lower system cost and easier installation procedure. Furthermore, as the illumination module of the present invention may be manufactured as an individual module, it can be expanded and maintained easily.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A light control system, comprising:
at least one illumination module, comprising:
an identification signal generator, configured to emit invisible light with a modulation frequency;
at least one light source;
a receiving unit, configured to receive a first wireless control signal and a second wireless control signal; and
a control circuit, controlling the identification signal generator to emit the invisible light when the receiving unit receives the first wireless control signal, and controlling the ON/OFF of the light source when the receiving unit receives the second wireless control signal; and
a remote controller, comprising:
a transmitter, configured to send the first wireless control signal and the second wireless control signal;
an image sensing module, acquiring the invisible light emitted from the identification signal generator to generate a plurality of images; and
a processing unit, identifying the illumination module according to the images, and controlling the transmitter to send the first wireless control signal and the second wireless control signal.

2. The light control system as claimed in claim 1, wherein the light source is selected from one or more of a fluorescent light, an incandescent lamp, a halogen light, a light emitting diode and an organic light emitting diode.

3. The light control system as claimed in claim 1, wherein the image sensing module acquires images with a sampling frequency that is a multiple of the modulation frequency.

4. The light control system as claimed in claim 1, wherein the image sensing module further comprises:
a filter, configured to block the light with a spectrum outside the spectrum of the invisible light;
an image sensor, configured to acquire the invisible light emitted from the identification signal generator to generate the plurality of images; and
a lens, configured to adjust the sensing efficiency of the image sensor.

5. The light control system as claimed in claim 1, wherein the light control system comprises a plurality of illumination modules, and the modulation frequency of the invisible light emitted by the identification signal generator of each illumination module is a multiple of that of other illumination modules.

6. The light control system as claimed in claim 5, wherein the image sensing module acquires images with a sampling frequency that is a common multiple of the modulation frequencies.

7. The light control system as claimed in claim 1, wherein the remote controller further comprises at least one button; when the button is pressed continuously, the processing unit controls the transmitter to send the first wireless control signal and controls the image sensing module to acquire the images; when the button is released, the processing unit controls the transmitter to send the second wireless control signal.

8. The light control system as claimed in claim 1, wherein the remote controller further comprises at least one button; when the button is pressed the first time, the processing unit controls the transmitter to send the first wireless control signal and controls the image sensing module to acquire the images; when the button is pressed the second time, the processing unit controls the transmitter to send the second wireless control signal.

9. The light control system as claimed in claim 1, wherein the identification signal generator is a light emitting diode or a laser diode.

10. The light control system as claimed in claim 1, wherein a frequency of the second wireless control signal is equal to the modulation frequency of the invisible light.

11. A control method of a light control system, the light control system comprising at least one illumination module and a remote controller, the illumination module comprising at least one light source, the control method comprising the steps of:
sending a first wireless control signal with the remote controller;
receiving the first wireless control signal and emitting an identification signal with the illumination module;
acquiring the identification signal with the remote controller to generate a plurality of images;
identifying the illumination module according to the images and accordingly sending a second wireless control signal with the remote controller; and
receiving the second wireless control signal with the illumination module and accordingly controlling the ON/OFF of the light source thereof.

12. The control method as claimed in claim 11, wherein the remote controller further comprises at least one button; when the button is pressed continuously, the remote controller sends the first wireless control signal; when the button is released, the remote controller sends the second wireless control signal.

13. The control method as claimed in claim 11, wherein the remote controller further comprises at least one button; when the button is pressed the first time, the remote controller sends the first wireless control signal; when the button is pressed the second time, the remote controller sends the second wireless control signal.

14. The control method as claimed in claim 11, wherein the identification signal is a modulated light signal with a modulation frequency.

15. The control method as claimed in claim 14, wherein in the step of acquiring the identification signal with the remote controller to generate a plurality of images, the remote controller acquires the images with a sampling frequency that is a multiple of the modulation frequency.

16. A control method of a light control system, the light control system comprising a plurality of illumination modules and a remote controller, each illumination module comprising at least one light source, the control method comprising the steps of:
sending a first wireless control signal to the plurality of illumination modules with the remote controller;
emitting different identification signals with the illumination modules respectively;
acquiring the identification signals with the remote controller to generate a plurality of images;
identifying different illumination modules with the remote controller according to the images; and
sending a second wireless control signal with the remote controller to the illumination modules to control the ON/OFF of the light source of selected illumination modules.

17. The control method as claimed in claim 16, wherein the identification signal is a modulated light signal with a modulation frequency.

18. The control method as claimed in claim 17, wherein the modulation frequency of the identification signal emitted by each illumination module is a multiple of that emitted by other illumination modules; and the remote controller acquires the images with a sampling frequency that is a common multiple of the modulation frequencies.

19. The control method as claimed in claim 18, wherein in the step of identifying different illumination modules with the remote controller according to the images, the remote controller identifies different illumination modules according to the regularity of the identification signals appeared in the captured images.

20. The control method as claimed in claim 16, wherein before the step of identifying different illumination modules with the remote controller according to the images, the control method further comprises the steps of:
setting a window of interest in the images; and
identifying the illumination modules in the window of interest according to the images and emitting a second wireless control signal to the illumination modules with the remote controller to control the ON/OFF of the light source of the illumination modules in the window of interest.
